(19) United States
(12) Patent Application Publication
(10) Pub. No.: US 2022/0400514 A1
(43) Pub. Date: Dec. 15, 2022

(54) CONTROLLING TRANSMISSION MEDIUM ACCESS IN AN OPEN SPECTRUM

(71) Applicant: Sony Group Corporation, Tokyo (JP)

(72) Inventor: Rickard LJUNG, Helsingborg (SE)

(21) Appl. No.: 17/770,249

(22) PCT Filed: Oct. 30, 2020
(86) PCT No.: PCT/EP2020/080503

§ 371 Date: Apr. 19, 2022

(30) Foreign Application Priority Data
Nov. 6, 2019 (SE) 1930362-7

(51) Int. Cl. H04W 74/08; H04L 5/00; H04W 16/14; H04W 74/00

(52) U.S. Cl. CPC H04W 74/0808; H04L 5/0094; H04W 16/14; H04W 74/006

(57) ABSTRACT

The present invention relates to a method (200) comprising selecting (201) a primary sub-band from multiple sub-bands of a BWP in an open spectrum, and transmitting (205) a message to a UE (20) indicative of the selected primary sub-band for a CCA of the BWP.

### TECHNICAL FIELD

Various examples relate to the field of accessing a transmission medium in an open spectrum, in particular to controlling access to a bandwidth part in an open spectrum.

### BACKGROUND

The use of mobile communication by means of cellular networks is popular in many industrial areas and areas of daily life. Cellular networks, for example cellular wireless radio networks, may include for example the Third Generation Partnership Project (3GPP), Long Term Evolution (LTE, sometimes also referred to as 4G), and 3GPP New Radio (NR, sometimes also referred to as 5G) technology. Cellular networks may comprise a plurality of cells with multiple nodes communicating within each cell to each other or with a base station of the cell.

Such cellular communication systems may be combined with the communication in an open spectrum (sometimes also referred to as unlicensed band). For communication in an open spectrum, the time-frequency resources are shared among multiple networks, operators, or more generally between any nodes that want to access the open spectrum. Therefore, resource allocation for communication may be complex. Typically, medium access to the open spectrum requires a Clear Channel Assessment (CCA) to ensure that resources for a transmission are available on the open spectrum. The CCA can include a Listen Before Talk (LBT) process. Regulatory constraints associated with the access of the open spectrum may include limitations of the maximum allowed channel occupancy per transmission attempt, limiting the time of each transmission after a successful LBT procedure. In a collision situation—e.g., due to a negative outcome of the LBT procedure —, the CCA may include a back-off. The back-off includes postponing a further transmission attempt, e.g., by a random timeout time duration.

Evolving cellular communication systems may utilize large carrier bandwidths. For example, 5G NR maximum carrier bandwidth is up to 100 MHz in frequency range 1 (FR1:450 MHz to 6 GHz), or up to 400 MHz in frequency range 2 (FR2:24.25 GHz to 52.6 GHz) that can be aggregated with a maximum bandwidth of 800 MHz. Accordingly, a concept referred to as bandwidth parts (BWPs) is employed, e.g., in the 3GPP 5G protocol. Briefly, BWPs can be used to subdivide the overall carrier bandwidth into smaller frequency ranges. Different BWPs can use different modulation and/or coding, e.g., different subcarrier spacing.

When a BWP is used for operation on an open spectrum, the BWP may be divided into multiple sub-bands. For example, a BWP may have a bandwidth of 100 MHz, and each sub-band may have a predefined bandwidth, for example 20 MHz, resulting in five sub-bands within the BWP.

Using multiple sub-bands can offer the benefit of simplifying the CAA. For example, a UE may select only one of the multiple sub-bands, a so-called primary sub-band, to perform the CCA including an LBT procedure including back-off; while the UE may perform the CCA on the other sub-bands of the BWP (secondary sub-bands) using the LBT procedure without back-off. The primary sub-band may be selected randomly (see for example 3GPP TS 37.213 V15.2.0).

It has been found that using a primary sub-band to simplify the CCA can cause increased likelihood of collisions between multiple UEs attempting to access the medium on the open spectrum. Thereby, transmission capacity may be reduced.

### SUMMARY

Therefore, a need exists for advanced techniques accessing the medium in an open spectrum, in particular when performing a CCA using a primary sub-band of a BWP.

This need is met by the features of the independent claims. The features of the dependent claims define embodiments.

A method comprises selecting a primary sub-band from multiple sub-bands of a frequency band in an open spectrum, and transmitting a message to a UE indicative of the selected primary sub-band for a clear channel assessment of at least one sub-band of the multiple sub-bands.

In the following examples, the remaining sub-bands of the multiple sub-bands of the frequency band in the open spectrum, which are not selected as the primary sub-band, will be called secondary sub-bands.

In various examples, the UE may perform a clear channel assessment (CCA) on the primary sub-band. In further examples, based on a result of the CCA on the primary sub-band, for example when the UE has determined that the primary sub-band is clear, the UE may estimate whether some or all of the secondary sub-bands are also clear. For example, based on a correlation information indicating that some or all of the secondary sub-bands are presumably clear when the primary sub-band is clear, the UE may estimate which sub-bands are expected to be clear also without explicitly monitoring these sub-bands. The correlation information may be preconfigured, or may be based on historical information collected by the UE based on monitored former clear states of the primary and secondary sub-bands, or may be based on configuration from the network.

In further examples, the UE may perform the CCA on the primary sub-band and may additionally perform CCA on one or more of the secondary sub-bands. For example, depending on a result of the CCA on the primary sub-band, the UE may perform the CCA on one or more of the secondary sub-bands. For example, when the UE determines that the primary sub-band is clear, the UE may perform the CCA on one or more of the secondary sub-bands. For instance, the CCA on the primary sub-band can include a listen before talk (LBT) procedure including back-off on the primary sub-band, and the CCA on the one or more secondary sub-bands can include LBT procedures without back-off on the corresponding secondary sub-bands.

In various examples, the UE may perform the CCA on the primary sub-band and may additionally perform CCA on each of the secondary sub-bands such that a CCA on all sub-bands of the frequency band in the open spectrum is performed. As an example, depending on a result of the CCA on the primary sub-band, the UE may perform the CCA on all secondary sub-bands. For instance, when the UE determines by use of a LBT including back-off that the primary sub-band is clear, the UE may perform LBT procedures without back-off on all secondary sub-bands.

Based on the above described CCA, the UE may subsequently use one, some or all of the sub-bands of the frequency band in the open spectrum for communicating control and/or payload data. For example, the UE may use those sub-bands, for which the UE has determined based on LBT procedures that the corresponding sub-bands are clear. Additionally, the UE may use those sub-bands, for which the UE has estimated that the corresponding sub-bands are clear. As a result, based on the CCA, the UE may use some or all sub-bands of the frequency band in the open spectrum.

To sum up, based on the CCA on the primary sub-band, the UE may infer—to some smaller or larger degree—whether it can access the medium on the one or more secondary sub-bands of the multiple sub-bands. For instance, the CCA on the one or more secondary sub-bands may not include a back-off; while the CCA on the primary sub-band can include the back-off. For instance, the CCA on the one or more secondary sub-bands may only be triggered by a successful LBT on the primary sub-band, i.e., can be conditional. Thus, the complexity of the CCA on the one or more secondary sub-bands can be reduced, by inferring knowledge from the primary sub-band.

The frequency band may comprise a bandwidth part (BWP) in the open spectrum, for example as defined in the 3GPP 5G protocol.

The method may be performed by a network node of a wireless communication network, for example by a base station (BS) or a mobility-control node of a core of the communication network.

Thus, the network may coordinate which UE of multiple UEs selects which primary sub-band for a CCA, for example to ensure that a given UE does not use a primary sub-band which is already allocated for data transmission to another UE by the network. Load balancing between the various sub-bands becomes possible. Furthermore, transmission energy on the different sub-bands may be coordinated, for example equalized.

As a general rule, the concepts described herein may be applicable to sub-bands of BWPs—e.g., in the framework of 3GPP 5G protocols—or sub-bands of other bands.

For example, selecting of the primary sub-band may be based on a determined utilization of at least one sub-band of the multiple sub-bands.

In various examples, selecting of the primary sub-band is based on a determined interference level on at least one sub-band of the BWP.

In further examples, selecting the primary sub-band is based on a predefined pseudo randomized scheme. In this example, although the selection of the primary sub-band seems to be randomized, there is still a control in the network which sub-band is used by a UE for each transmission attempt. The predefined pseudo randomized scheme may include a predefined scheme or formula which is known to the network node and the UE, for example like a frequency hopping scheme. The selected primary sub-band may be revealed based on the scheme or formula and based on a frame timing or a frame numbering. The frame timing or the frame numbering may be used as a pointer in the scheme or as an input value to the formula. Other numbering or timing schemes may be provided for selecting the primary sub-band using the scheme or formula. Such numbering or timing schemes may be synchronized in the network node and the UE by communicating for example a seed value or a synchronization message. A plurality of formulas or schemes may be the predefined and known to the network node and the UE, and the network node may indicate which formula or scheme to be used, for example by communicating a corresponding message.

In various examples, the message indicating the selected primary sub-band may be transmitted as downlink (DL) control information (DCI), for example in a physical DL control channel (PDCCH). This type of signaling may enable very fast information sharing to the UE just before the UE will initiate its CCA. Additionally or as an alternative, the message may be transmitted in a radio resource control signaling (RRC) which would typically be less frequent and thus facilitates reducing control-signaling overhead. Alternatively or additionally, the message may be broadcasted, for example on a cell level.

The message may comprise a bandwidth information indicative of the selected primary sub-band, for example providing values indicating a lower frequency and an upper frequency of a frequency range of the selected primary sub-band, or values indicating a center frequency and a bandwidth of the selected primary sub-band.

Additionally or as an alternative, the message may comprise an indicator of one or more entries of a codebook of multiple candidate sub-bands, or a formula or scheme to determine a next primary sub-band to be selected based on the previously selected primary sub-band.

The indicator may be indicative of a selection sequence of the one or more entries of the codebook, or a seed primary sub-band for the formula. For instance, the selection sequence can indicate a toggling scheme for iteratively selecting different primary sub-bands.

A computer program or a computer-program product includes program code that may be executed by at least one processor. Executing the program code causes the at least one processor to perform a method. The method includes selecting a primary sub-band from multiple sub-bands of a frequency band in an open spectrum, and transmitting a message to a UE indicative of the selected primary sub-band for a CCA of a sub-band of the multiple sub-bands of the frequency band.

A network node comprises control circuitry. The control circuitry is configured to select a primary sub-band from multiple sub-bands of a frequency band in an open spectrum, and to transmit a message to a UE indicative of the selected primary sub-band for a CCA of a sub-band of the multiple sub-bands of the frequency band.

A method comprises receiving a message from a network node of a wireless communication system. The message is indicative of a selected primary sub-band from multiple sub-bands of a frequency band in an open spectrum. The method furthermore comprises performing a CCA of a sub-band of the multiple sub-bands of the frequency band based on the selected primary sub-band.

The method may be performed by a UE.

The frequency band may comprise a bandwidth part (BWP) in the open spectrum, for example as defined in the 3GPP 5G protocol.

In various embodiments, the CCA comprises a primary LBT procedure including back-off in the primary sub-band. Furthermore, the CCA may comprise a conditional secondary LBT procedure without back-off in one or more secondary sub-bands of the multiple sub-bands. In other words, the communication network may indicate which part of the BWP to use as the primary sub-band on which the UE shall perform a comprehensive and detailed assessment, for example a LBT procedure including a random back-off. Therefore, the network controls on which sub-band the full LBT procedure will be conducted and on which other sub-bands of the BWP only a reduced/shortened LBT procedure without back-off is conducted. The network may continue to use the sub-bands on which the reduced LBT procedure is performed until the UE performs the LBT procedure on these sub-bands. The network may thus better utilize the available resources since it does not need to keep all sub-bands of a BWP available during the full LBT time interval.

The message from the network node may be received in a DL control information, a radio resource control signaling, or a broadcast message including an indication of the selected primary sub-band.

For example, the message may comprise a bandwidth information, which indicates the selected primary sub-band, for example by means of one or more frequency values or an index representing the sub-band.

According to various examples, the message comprises an indicator of one or more entries of a codebook of multiple candidate sub-bands. For example, the indicator may indicate a selection sequence of the one or more entries of the codebook. For example, a scheme or codebook on the selection of the primary sub-band may be provided to the UE. The scheme may be a pseudo random scheme so that, although the selection of the primary sub-band seems to be randomized, there is still a control in the network which sub-band will be used by the UE for each transmission attempt or assessment. The scheme may be provided in a specification or when the UE registers at a cell of the network. The indicator may comprise a seed or a sequence indicator key indicating an entry of the scheme.

A computer program or a computer-program product includes program code that may be executed by at least one processor. Executing the program code causes the at least one processor to perform a method. The method includes receiving a message from a network node of a wireless communication system, wherein the message is indicative of a selected primary sub-band from multiple sub-bands of a frequency band in an open spectrum. The method furthermore includes performing a CCA of a sub-band of the multiple sub-bands of the frequency band based on the selected primary sub-band.

A UE comprises control circuitry. The control circuitry is configured to receive a message from a network node of a wireless communication system, wherein the message is indicative of a selected primary sub-band from multiple sub-bands of a frequency band in an open spectrum. The control circuitry is further configured to perform a CCA of a sub-band of the multiple sub-bands of the frequency band based on the selected primary sub-band.

A system includes a network node and a UE. The network node comprises control circuitry. The control circuitry is configured to select a primary sub-band from multiple sub-bands of a frequency band in an open spectrum, and to transmit a message to the UE indicative of the selected primary sub-band for a CCA a sub-band of the multiple sub-bands of the frequency band. The UE comprises control circuitry. The control circuitry is configured to receive the message from the network node. The control circuitry is further configured to perform a CCA of a sub-band of the multiple sub-bands of the frequency band based on the selected primary sub-band.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

The present invention will now be described in more detail with reference to the accompanying drawings.

FIG. 1 schematically shows a communication system comprising a network node and a UE according to embodiments of the present invention.

FIG. 2 shows a method comprising method steps according to embodiments of the present invention.

FIG. 3 shows a further method comprising method steps according to embodiments of the present invention.

FIG. 4 illustrates BWPs in an open spectrum.

FIG. 5 illustrates sub-bands of a BWP.

FIG. 6 illustrates a CCA according to embodiments of the present invention.

FIG. 7 illustrates a CCA according to further embodiments of the present invention.

### DETAILED DESCRIPTION OF EMBODIMENTS

In the following, exemplary embodiments of the present invention will be described in more detail. It is to be understood that the features of the various exemplary embodiments described herein may be combined with each other unless specifically noted otherwise. Any coupling between components or devices shown in the figures may be a direct or indirect coupling unless specifically noted otherwise. A coupling between components may also be established over a wireless connection. Functional blocks may be implemented in hardware, firmware, software or a combination thereof.

The drawings are to be regarded as being schematic representations and elements illustrated in the drawings are not necessarily shown to scale. Rather, the various elements are represented such that their function and general purpose become apparent to a person skilled in the art.

In the following, techniques of transmitting and/or receiving (communicating) data between a first node and a second node of a wireless communication system are disclosed. The data may correspond, for example, to payload data of applications implemented by the first node and/or the second node. Alternatively or additionally, the data may correspond to control data, for example layer 2 or layer 3 control data according to the Open Systems Interface (OSI) model. The data may comprise uplink (UL) data or DL data.

The first node may be implemented by a UE, for example a mobile device such as a mobile telephone or a mobile computer, an Internet of Things (IoT) device, or a Machine Type Communication (MTC) device. The second node may be implemented by an access node of a communication network, e.g., a BS. The second node may also be implemented by another UE, e.g., in which case it would be possible to use device-to-device (D2D) communication on a sidelink of a communications network.

The various techniques described herein may be in particular applicable for transmission on an open spectrum. Multiple operators or networks may share access to the open spectrum. In other words, access to the open spectrum may not be restricted to a single operator or network. Typically, the communication on the open spectrum may involve a CCA. The CCA can include LBT procedures and optionally back-off. Such techniques are sometimes also referred to as Carrier Sense Multiple Access/Collision Avoidance (CSMA/CA). Alternatively or in combination with requirements on CCA, the communication on the open spectrum may involve a maximum channel occupancy time. The maximum channel occupancy time may restrict a transmitting node to limit a transmission on the open spectrum to a maximum time duration after a successful LBT.

Various techniques are applicable on using the radio access technology (RAT) of a cellular network on the open spectrum. For instance, the RAT according to the 3GPP 5G protocol may be used to communicate on the open spectrum.

Such RATs can, in particular, offer the benefit of segmenting an overall band into multiple sub-bands. Such segmentation can, as a general rule, occur on various levels. A first level would be that the overall carrier bandwidth is segmented into the sub-bands. Another level would be that the overall carrier bandwidth is segmented into BWPs; each BWP, can in turn, be segmented into respective sub-bands. Hereinafter, various examples will be described in the context of employing BWPs. Each BWP can include multiple sub-bands. Similar techniques, however, may be readily applied to other concepts of subbands, e.g., without employing BWPs.

As a general rule, a BWP can denote a subset of contiguous common physical resource blocks (PRBs) of a time-frequency resource grid. Each PRB includes a number of adjacent time-frequency resource elements of the time-frequency resource grid. A BWP may be a subsection/subpart of an overall bandwidth available for communication with mobile devices (user equipment, UE), e.g., defined by a carrier. Scheduling of resources may be with reference to the respective BWP; thereby, BWPs enable increased flexibility in how resources are scheduled in a given carrier. For example, different BWPs may employ different modulation and/or coding schemes. For example, different BWPs may employ different subcarrier spacings of an Orthogonal Frequency Division Multiple (OFDM) modulation. Accordingly, BWPs may provide flexibility so that multiple, different signal types can be sent in a given bandwidth. Thus, BWPs may enable multiplexing of different signals and signal types for better utilization and adaptation of spectrum and user equipment power. With BWPs, a carrier may be subdivided and used for different purposes. Each 5G NR BWP may have its own numerology, meaning that each BWP can be configured differently with its own signal characteristic, enabling more efficient use of the spectrum and more efficient use of power. This feature may be advantageous for integrating signals with different requirements. One BWP may have reduced energy requirements, while another BWP may support different functions or services, and yet another BWP may provide coexistence with other systems. BWPs may support 4G devices with 5G devices on the same carrier. Possible that each BWP, in turn, includes multiple sub-bands.

As a general rule, multiple sub-bands may employ the same numerology, i.e., subcarrier spacing and/or modulation and coding scheme. For example, scheduling of time-frequency resources may be implemented on band-level, i.e., across the multiple subbands. For example, DL control information including a scheduling message such as a UL scheduling grant or a DL scheduling assignment may reference time-frequency resources across all sub-bands. The concept of subbands may, in particular, be helpful in connection with CCA on the open spectrum. In particular, the CCA may include multiple LBTs for the multiple sub-bands. A primary sub-band may be used for a primary LBT; and secondary LBTs that are conditional on the outcome of the primary LBTs may be implemented on secondary subbands.

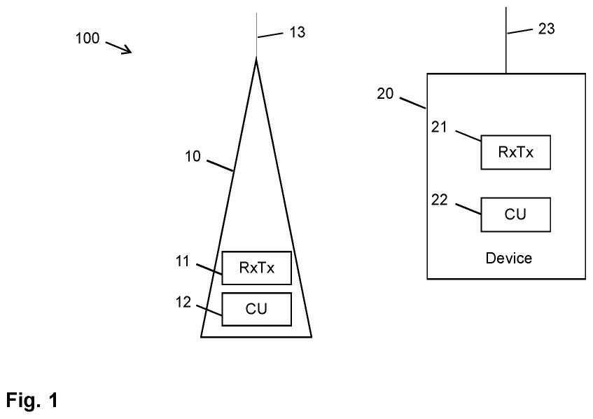

FIG. 1 shows schematically a wireless communication network 100 comprising a network node 10, for example a BS, and a UE 20. The wireless communication network 100 may comprise a cellular network implementing for example the 3GPP LTE or 5G NR architecture or other types of networks, for example Institute of Electrical and Electronics Engineers (IEEE) 802.11X wireless local area network, Bluetooth or Zigbee.

The UE 20 may comprise for example a smartphone, a cellular phone, a tablet, a notebook, a computer, a smart TV, an MTC device, an IoT device or any other type of communication device. An MTC or IoT device is typically a device with a low to moderate requirement on data traffic volumes and loose latency requirements. Communication employing MTC or IoT devices should achieve low complexity and low costs. Energy consumption of an MTC or an IOT device should be comparably low in order to allow battery-powered devices to function for comparably long duration. The UE 20 may be configured to communicate on an open spectrum. Accordingly, the UE 20 may be configured to implement CCA.

The BS 10 may for example implement the evolved UMTS terrestrial radio access technology (E-UTRAN) or may comprise a gateway of a wireless local area network (WLAN). Additionally or as an alternative, the BS 10 may provide communication on an open spectrum, e.g., using CCA. Thus, a communication between the UE 20 and the BS 10 on an open spectrum may be provided.

The BS 10 comprises a transceiver 11 (RxTx), a control unit 12 (CU), and an antenna 13. The UE 20 comprises a transceiver 21 (RxTx), a control unit 22 (CU), and an antenna 23. In the wireless communication system 100, a plurality of BSs 10 and a plurality of UEs 20 may be present. Therefore, a plurality of UEs may try to gain access to wireless communication channels in the open spectrum. For avoiding collisions when two or more UEs are trying to transmit data simultaneously on the same wireless communication channel, the CCA can be employed.

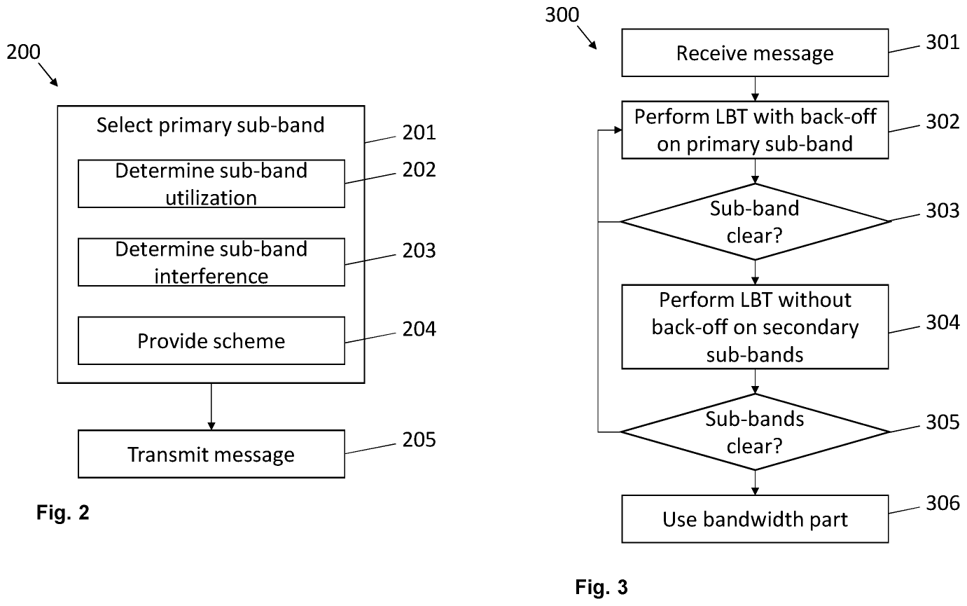

FIG. 2 shows a flowchart of a method 200, which may be executed by the BS 10 for assisting the UE 20 in gaining access to a wireless communication channel in an open spectrum. FIG. 3 shows a flowchart of a method 300, which may be executed by the UE 20 when gaining access to the wireless communication channel in the open spectrum.

Method 200 comprises method steps 201 to 205 which may be executed for example by the control unit 12 of the BS 10, e.g., upon loading respective program code. Method 300 comprises method steps 301 to 306 which may be executed for example by the control unit 22 of the UE 20, e.g., upon loading respective program code.

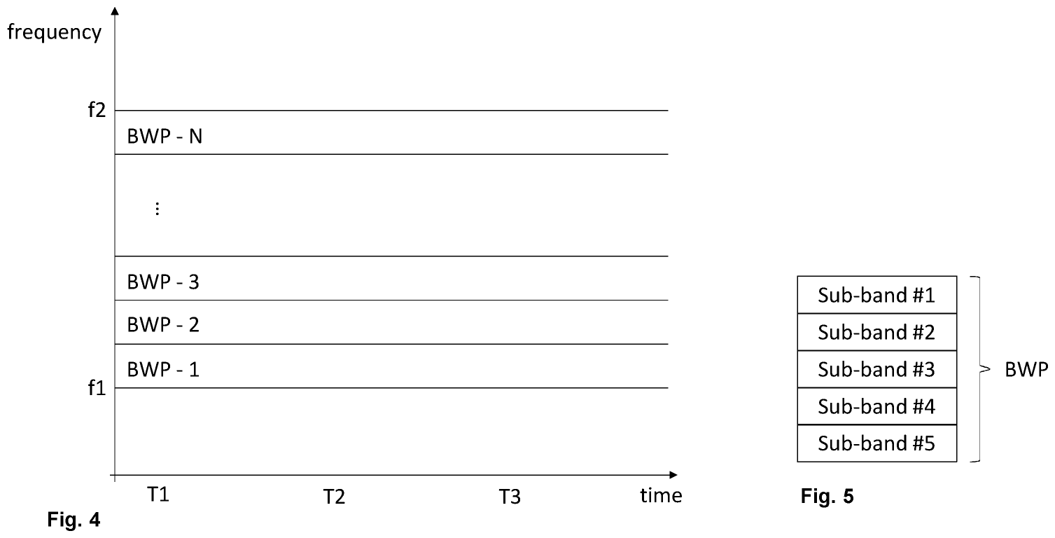

A wireless communication channel between two nodes established on the open spectrum may comprise a plurality of BWPs, each BWP comprising a plurality of sub-bands. FIG. 4 shows an open spectrum in a frequency range from f1 to f2. In the exemplary illustration of FIG. 4, the open spectrum may comprise a number of N BWPs, BWP-1 to BWP-N. The open spectrum may comprise any number of BWPs, e.g., N may be typically dimensioned in the range of N=1 . . . 60. For example, an open spectrum comprising an unlicensed 5 GHz band may comprise 50 BWPs, each having a bandwidth of 100 MHz. A UE may gain medium access on the BWP for using the BWP for communicating data, e.g., for a certain amount of time. A time interval for usage of one BWP may be independent from a time interval of usage of another BWP. For example, one UE may use BWP-1 during time interval from T1 to T2 and next another UE may use BWP-1 during time interval from T2 to T3, and then yet another UE may use BWP-1 starting at time interval T3. In parallel, the UEs or even further UEs may use other BWPs, for example BWP-3, during the same or other, shorter or longer time intervals. Accordingly, using BWPs on the open spectrum facilitates efficient medium access and, in particular, can help to reduce latency of the medium access.

FIG. 5 illustrates aspects with respect to sub-bands. FIG. 5 shows an exemplary BWP, for example BWP-1. For example, the BWP may be arranged in an unlicensed 5 GHz band and may have a bandwidth of 100 MHz. The BWP may be divided into five sub-bands having each a bandwidth of 20 MHz. However, the BWP is not limited to the above example. For example, the BWP may be arranged in a 50 or 60 GHz band and may comprise more than five sub-bands, for example 10 sub-bands. Furthermore, also the bandwidth of each sub-band is not limited to the above mentioned bandwidth of 20 MHz, but may have a different bandwidth, for example 10 MHz, 40 MHz, or 50 MHz. When the UE 20 wants to gain access to a BWP for transmitting control or payload data in the BWP, the UE 20 may perform a CCA of the BWP. The UE 20 may perform a so-called full LBT procedure on only one of the sub-bands of the BWP, and may perform a reduced or short LBT procedure on the remaining sub-bands of the BWP. The full LBT procedure includes a back-off according to which the UE 20 waits for each failed attempt of medium access for a back-off time period, which is randomly selected within a contention window size length. The contention window size length may be adjusted, in particular increased, for each failed attempt. In the short LBT procedure, the UE may not use such contention window, but may continuously monitor the sub-band until it is clear. The short LBT procedure may, in some examples, be conditional on the outcome of the full LBT procedure; i.e., it is not possible to obtain a positive outcome of the short LBT procedure without a positive outcome of the long LBT procedure. The UE 20 may start using the BWP for payload or control transmission when all sub-bands are detected to be clear.

The above described techniques will now be described in further detail in connection with the flowcharts of FIG. 2 and FIG. 3.

In step 201, the network node 10 selects a primary sub-band from the multiple sub-bands of the BWP in the open spectrum.

As a general rule, various decision criteria are conceivable to be considered in the selection of step 201. Selecting the primary sub-band by the network node 10 may consider overall network performance. For example, in optional step 202, the network node 10 may determine a utilization of each sub-band in the BWP. The network node 10 may have knowledge concerning how each sub-band is utilized. The network node 10 may determine how many time-frequency resources are scheduled by the network node 10 on each sub-band. Therefore, selecting a specific sub-band from the multiple sub-bands as the primary sub-band for the CCA in the UE 20 may enable that the remaining sub-bands of the BWP can be efficiently used by other communications in the communication system until the full LBT procedure on the primary sub-band has succeeded.

Additionally or as an alternative, in optional step 203, the network node 10 may determine interference on each sub-band in the BWP, and may select the primary sub-band based on the determined interference. For example, the network noted 10 may select the sub-band having the lowest interference as the primary sub-band. The interference may be determined, e.g., by sensing an activity on each of the sub-bands. For example, it would be possible to measure a power-spectral density on each sub-band.

Additionally or as an alternative, in optional step 204, the network node 10 may provide a scheme for selecting the primary sub-band. For example, when performing the full LBT procedure in a sub-band in which the communication system is scheduling other traffic during the full LBT procedure, the likelihood that the UE determines that the sub-band is a clear is low. Hence, a coordination between the network traffic and the primary sub-band selection for the UE 20 may be advantageous for achieving high system throughput. Such a coordination may be mapped to a scheme which is shared with the UE 20. For example, the scheme may be provided by specification or may be communicated between the network node 10 and the UE 20, for example at an initial registration of the UE 20 at the network or the network node 10. Such a scheme may define for example a corresponding primary sub-band for CCA of subsequent time intervals in the BWP, for example for the subsequent time intervals T1 to T2, T2 to T3 and so on of BWP-1 in FIG. 4. For example, the corresponding scheme may be provided for each BWP. For instance, it would be possible to use different schemes for different UEs. For instance, the scheme may depend on a UE identity.

In step 205, a message which indicates the selected primary sub-band is transmitted to the UE 20.

The network node 10 may transmit control signaling to the UE 20, for example within a PDCCH (Physical DL control channel). Information elements in such control signaling may include scheduling information for upcoming transmissions of the UE 20. Such information elements may be denoted as DL control information (DCI). The information on the selected primary sub-band may be included in this type of control signaling. This may enable very quick information sharing with the UE 20 just before the UE 20 will initiate its listen before talk procedure for a scheduled transmission.

Other signaling alternatives for a less frequent (less dynamic) approach could be to include the information on the selected primary sub-band in a radio resource control (RRC) signaling. A further alternative for transmitting the information concerning the selected primary sub-band from the network node 10 to the UE 20 is using a broadcasted signaling.

It is to be noted that there are several possibilities to achieve a pseudo randomness of the usage of the primary sub-band. One possibility is to provide a pseudo random scheme to the UE 20 based on the selection of the primary sub-band by the network node 10, so that, although the selection of primary sub-band seems to be randomized at least to some degree, there is still a knowledge in the network which primary sub-band will used by the UE for each transmission attempt. For example, such pseudo-random scheme may implement multiple subsequent selections of different primary sub-bands. The average selection probability—across a sufficiently long averaging time window—for each respective candidate sub-band may be the same or substantially the same. I.e., in other words, over the course of time each candidate sub-band would be selected as a primary sub-band for the same amount of time or at the same number of occasions. On the other hand, the sequence of selections can be deterministic. I.e., if a first one of the multiple candidate sub-bands is selected as the current primary sub-band, this may already deterministically define which second one of the multiple candidate sub-bands will be subsequently selected as the next primary sub band.

Further, when the scheme for selecting the primary sub-band is provided to the UE 20, for example in a specification or by configuration from the network node 10, the UE 20 may receive a seed or a sequence indicator key or similar from the network node 10 for selecting the primary sub-band. For example, the initially selected sub-band may define the subsequent selection sequence, e.g., fully or in conjunction with other parameters such as the identity of the UE 20. The scheme may comprise for example a table, list or sequence of primary sub-bands to be used, or a formula with which a next primary sub-band to be used may be calculated based on a previously used primary sub-band and/or depending on an identity of the UE 20.

In step 301, the UE 20 receives, from the network node 10, the message which indicates the primary sub-band which was selected by the network node 10 for the CCA of the BWP.

In step 302, the UE 20 performs the CCA of the BWP based on the primary sub-band by performing a LBT procedure with back-off on the primary sub-band. For example, the UE 20 may monitor the primary sub-band to determine whether the primary sub-band is clear, for example by determining whether data is communicated within the primary sub-band or whether a transmission energy level on the primary sub-band is above a predefined threshold. When, in step 303, the UE 20 determines that the primary sub-band is not clear, for example when data is communicated within the primary sub-band or the transmission energy level on the primary sub-band is above the predefined threshold, the UE 20 may start a timer and may wait for a randomly selected back-off time before returning to step 302 for a next assessment of the primary sub-band. In case the UE 20 determines in step 303 that the primary sub-band is clear, the method is continued in step 304. In step 304, the UE 20 performs LBT procedures on the other sub-bands, the so-called secondary sub-bands, of the BWP. For example, the UE 20 may monitor each secondary sub-band to determine whether the secondary sub-bands are clear, for example by determining whether data is communicated within the secondary sub-band or whether a transmission energy level on the secondary sub-band is above a predefined threshold. When, in step 305, the UE 20 determines that all the secondary sub-bands are clear, for example when no data is communicated on each of the secondary sub-bands and the transmission energy level on each secondary sub-band is below the predefined threshold, the UE may start using the BWP in step 306. This includes communicating on time-frequency resource elements across the entire BWP, i.e., across all sub-bands. Thus, as will be appreciated, the CCA for the entire BWP is facilitated by, firstly, performing the LBT on the primary sub-band and, secondly and conditionally on the outcome of the LBT on the primary sub-band performing the LBTs on the one or more secondary sub-bands.

In case the UE 20 determines in step 305 that not all secondary sub-bands are clear, the method may be continued in step 302 with performing the LBT procedure with back-off one the primary sub-band. As an alternative, in case in step 305 the UE 20 determines that not all secondary sub-bands are clear, the method may be continued in step 301 with receiving a further message from the network node 10 indicating another primary sub-band for the following CCA of the BWP.

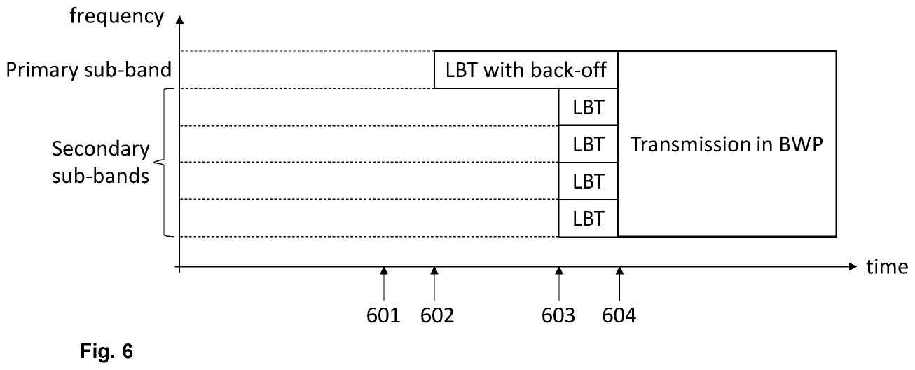

FIG. 6 illustrates an example of conducting LBT procedures on sub-bands of the BWP according to the above described methods. At 601, a message is communicated from the network node 10 to the UE 20 which indicates a primary sub-band to be used for a CCA of a BWP. When the UE 20 wants to use the—e.g., entire— BWP for communicating data, the UE 20 starts at 602 a LBT procedure including back-off in the primary sub-band indicated in the message. When the LBT procedure started at 602 is nearly finished and reveals that the primary sub-band is clear so far, the UE 20 additionally performs LBT procedures without back-off in the other sub-bands of the BWP, the so-called secondary sub-bands, at 603. In case the LBT procedures performed on the primary sub-band and the secondary sub-bands reveal that the sub-bands are clear, the UE 20 starts with a data transmission in the BWP at 604, e.g., using time-frequency resource elements across the entire bandwidth of the BWP. Thus, while the LBTs are segmented using the sub-bands, the BWP is utilized coherently for transmission.

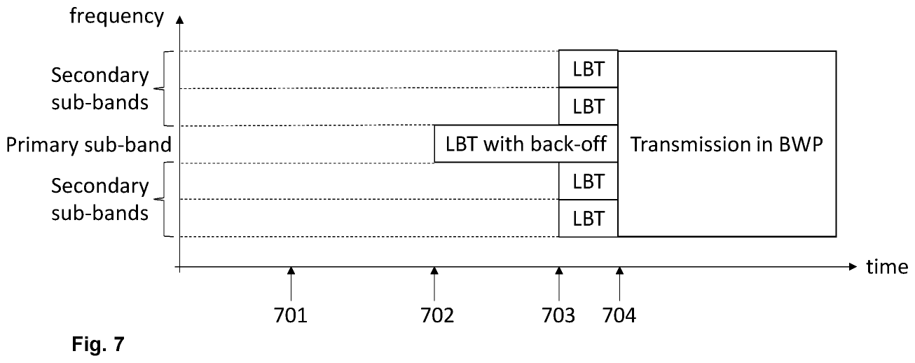

FIG. 7 illustrates a further example of conducting LBT procedures on sub-bands of a BWP according to the above described methods. The example shown in FIG. 7 differs from the example shown in FIG. 6 in that the selected primary sub-band for conducting the LBT procedure including back-off is different, i.e. instead of a sub-band comprising the highest frequency band of the BWP as shown in FIG. 6, the primary sub-band comprises a frequency band in the center of the BWP. However, LBT procedures are conducted in a similar way on the sub-bands. At 701, a message is communicated from the network node 10 to the UE 20 which indicates the primary sub-band to be used for a CCA of a BWP. The message indicates a frequency band in the center of the BWP. When the UE 20 wants to use the BWP for communicating data, the UE 20 starts at 702 a LBT procedure including back-off in the indicated primary sub-band in the center of the BWP. When the LBT procedure started at 702 is nearly finished, at 703, the UE 20 additionally performs LBT procedures without back-off in the other sub-bands of the BWP, i.e. in the secondary sub-bands in the frequency ranges above and below the primary sub-band. In case the LBT procedures performed on the primary sub-band and the secondary sub-bands reveal that the sub-bands are clear, at 704, the UE 20 starts transmitting data in the BWP.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, various techniques have been described in the context of multiple sub-bands being part of a BWP. As a general rule, it is not germane for the techniques described herein in connection with selecting a primary sub-band from the multiple sub-bands to employ the concept of BWPs.

1. A method of a network node comprising:
selecting a primary sub-band from multiple sub-bands of a frequency band in an open spectrum, and
transmitting a message to a communication device indicative of the selected primary sub-band for a clear channel assessment of at least one sub-band of the multiple sub-bands of the frequency band.

2. The method of claim 1, wherein said selecting of the primary sub-band is based on a determined utilization of at least one sub-band of the multiple sub-bands.

3. The method of claim 1, wherein said selecting of the primary sub band is based on a determined interference level on at least one sub-band of the multiple sub-bands.

4. The method of claim 1, wherein said selecting of the primary sub-band is based on a predefined pseudo randomized scheme.

5. The method of claim 1, wherein transmitting the message to the communication device comprises at least one of:
transmitting the message in a downlink control information,
transmitting the message in a radio resource control signaling, and broadcasting the message.

6. The method of claim 1, wherein the message comprises a bandwidth information indicative of the selected primary sub-band.

7. The method of claim 1, wherein the message comprises an indicator of one or more entries of a codebook of multiple candidate sub-bands.

8. The method of claim 7, wherein the indicator is indicative of a selection sequence of the one or more entries of a codebook.

9. The method of claim 1, wherein the clear channel assessment comprises a primary listen before talk procedure including back off on the primary sub-band and further comprises, depending on an outcome of the listen before talk procedure on the primary sub-band, a conditional secondary listen before talk procedure without back-off on one or more secondary sub bands of the multiple sub-bands.

10. A method of a communication device comprising:
receiving a message from a network node of a wireless communication system, the message being indicative of a selected primary sub-band from multiple sub-bands of a frequency band in an open spectrum, and
performing a clear channel assessment of at least one sub-band of the multiple sub-bands of the frequency band based on the selected primary sub-band.

11. The method of claim 10, wherein the clear channel assessment comprises a primary listen before talk procedure including back-off on the primary sub-band and further comprises, depending on an outcome of the listen before talk procedure on the primary sub-band, a conditional secondary listen before talk procedure without back off on one or more secondary sub-bands of the multiple sub-bands.

12. The method of claim 10, wherein receiving the message from the network node comprises at least one of:
receiving the message in a downlink control information,
receiving the message in a radio resource control signaling, and
receiving a broadcast message.

13. The method of claim 10, wherein the message comprises a bandwidth information indicative of the selected primary sub-band.

14. The method of claim 10, wherein the message comprises an indicator of one or more entries of a codebook of multiple candidate sub-bands.

15. The method of claim 14, wherein the indicator is indicative of a selection sequence of the one or more entries of the codebook.

16. A network node comprising control circuitry configured to select a primary sub-band from multiple sub-bands of a frequency band in an open spectrum, and
transmit a message to a communication device indicative of the selected primary sub-band for a clear channel assessment of at least one sub-band of the multiple sub-bands of the frequency band.

17-19. (canceled)
